(19) United States
(12) Patent Application Publication
(10) Pub. No.: US 2002/0091555 A1
(43) Pub. Date: Jul. 11, 2002

(54) Fraud-proof internet ticketing system and method

(76) Inventor: David Morgan Leppink, Magna, UT (US)

Correspondence Address: Vanessa B. Pierce, Parsons Behle & Latimer, One Utah Center, 201 South Main Street, Suite 1800, Salt Lake City, UT, 84145-0898, US

(21) Appl. No.: 10/027,479

(22) Filed: Dec. 21, 2001

Related U.S. Application Data
(60) Provisional application No. 60/258,165, filed on Dec. 22, 2000.

(51) Int. Cl. G06F 17/60

(52) U.S. Cl. 705/5

(57) ABSTRACT

An Internet-based, print-at-home, ticketing technology that allows customers to purchase tickets for an event date and show time, if applicable, print the tickets on standard paper using their own printer, and bypass the box office lines at the venue. Customers can proceed directly to the ticket-taker at the venue, present their tickets, and gain admission. The ticket is validated using fraud-proof ticketing software that scans the bar code or other electronic insignia on the printed ticket and ensures that the ticket can never be used twice, thereby preventing fraud through photocopying, double use, etc. For further security, continuous data synchronization with the Internet server guarantees that any attempts at forgery are immediately detected. Customers may also purchase concession stand items as part of their on-line transaction, a certificate for which is printed as part of the ticket. Once validated, this certificate can be exchanged at the concession stand for the appropriate items.

### BACKGROUND OF THE INVENTION

1. The Field of the Invention

The present invention is related generally to systems and methods for providing tickets to various venues, and more particularly, to providing fraud-proof tickets to the venues.

2. The Relevant Technology

While entertainment venues such as movies, plays, concerts, sports, amusement parks, and the like, have become increasingly popular, standing in line for tickets to access these venues has not. Movies, for example, and especially popular movies, require a customer to stand in a long line to purchase a ticket, in another line to buy concessions, and in yet another line to enter the theater for seating. Often times the movie sells out before the customer even reaches the front of the ticket line.

In addition, the movie theater personnel may be unable to meet the demand for tickets in time for the movie to start. This situation results in unhappy customers who miss the beginning of the movie and have to find seats in the dark, or who simply leave with a bad impression of the theater.

Extremely long lines for ticket purchases also plague amusement parks. These long lines particularly vex the customer accompanied by anxious children during a hot, sticky summer day.

Commerce on the Internet has been rapidly expanding to include numerous industries. One drawback to most on-line purchases, however, is that the purchase itself often introduces additional inconvenience. For example, methods that purport to provide on-line ticketing actually rely upon either a confirmation number that a customer presents at the box office to pick up tickets purchased on-line, or a will-call system wherein the customer picks up pre-printed tickets from a special window. Both methods perpetuate the inconvenience of on-line purchasing in that they actually add one or more additional steps to the traditional process of purchasing tickets at the box office window. Further, a customer using these methods must stand in line with other attendees to obtain the ticket at the box office or at the will-call window. In addition, the venues often require customers using these methods to present the credit card that the customer used to make the on-line purchase. The customer also must pay cash for concessions in a separate transaction.

### SUMMARY AND OBJECTS OF THE INVENTION

It is therefore an object of the present invention to provide efficient systems and methods for simplifying the purchase of tickets to a particular venue, such as a movie, concert, theme park, etc.

It is another object of the present invention to provide systems and methods for bypassing a venue's ticket counter, or “box office”.

Still another object of the invention is to provide systems and methods for purchasing a ticket to an event via an Internet server.

Yet another object of the invention is to provide systems and methods for printing a ticket at home, work, school, etc.

It is another object of the present invention to provide systems and methods for gaining admission to a venue by presenting a ticket printed at home, work, school, etc.

It is still another object of the present invention to provide systems and methods for preventing fraud with respect to a ticket purchased on-line and printed at home, work school, etc.

Still another object of the invention is to provide methods and systems for providing real-time integration with a box office computer system and the on-line ticketing system.

These and other objects and features of the present invention will become more fully apparent from the following description and appended claims, or may be learned by the practice of the invention as set forth hereinafter.

The present invention provides an Internet-based, print-at-home, ticketing technology that allows customers to purchase a ticket for a specific event date and show time, if applicable, print the bar coded ticket on standard paper using their own printer, and bypass the box office lines at the venue. The fraud-proof Internet ticketing system and method of the present invention allows customers to proceed directly to the ticket-taker at the venue, present their ticket, and gain admission to their event. The ticket is validated using fraud-proof ticketing software that scans the bar code printed on the customer's ticket and ensures that the ticket can never be used twice, thereby preventing fraud through photocopying, double use, etc.

For further security, continuous data synchronization with the Internet server for the ticketing system and method guarantees that any attempts at ticket forgery are immediately detected.

As an added convenience, customers may also purchase concession stand items as part of their on-line transaction, a certificate for which is printed as part of the ticket. Once validated, this certificate can be exchanged at the concession stand for the appropriate items.

### DETAILED DESCRIPTION

As noted above, commerce on the Internet has been rapidly expanding to include numerous industries. One drawback to most on-line purchases, however, is that the purchase itself often introduces additional inconvenience. The Internet ticketing system and method of the present invention actually makes the process of buying an event ticket on-line and redeeming that ticket at a venue more convenient than the process of purchasing a ticket at the brick-and-mortar box office.

The present invention provides a “complete circle” method and system for ticket issuance and validation to prevent fraud and generate convenience for the user. The system and method of the present invention actually eliminate steps from the process of purchasing tickets for an event, thereby allowing customers to bypass the lines at the box office window, pick up their concessions without carrying any cash or credit cards in their pockets, and enjoy increased convenience as a reward for making their purchase on-line.

A preferred embodiment of the system of the present invention includes the following: Internet server(s) through which bar coded tickets are sold and statistical information is tracked; venue computer system(s), equipped with hardware and software to validate tickets and configure venue and event settings on the Internet server(s); reliable Internet connection of any type and bandwidth between the user and the Internet server; and reliable Internet connection of any type and bandwidth between the venue computer system and the Internet server.

Typically, the connection used by the user is a basic modem dial-up connection, but may alternatively be a high-speed dedicated circuit, a DSL or Cable connection, a wireless connection, or any other type of connection technology available to the user. The Internet server preferably is connected to the Internet via a high-speed dedicated circuit. In addition, the connection used by the venue computer system is a basic modem dial-up connection, but could also be a high-speed dedicated circuit, a DSL or Cable connection, a wireless connection, or any other type of connection technology available to the venue.

In another embodiment, integration is provided with the venue's box office computer system to facilitate control and tracking of ticket sales and event management in the Internet ticketing system on-line database.

A preferred method in accordance with the present invention includes issuing a ticket in accordance with the present invention, notifying the venue that a ticket has been sold, controlling the inventory of on-line tickets available for sale, and validating a ticket that has been presented for redemption.

In one preferred embodiment, the method for issuing a bar coded Internet ticket includes the following steps. First, a customer or user desiring to use the Internet ticketing system preferably has access to the Internet, such as, but not limited to, through her personal computer at home, work, or school. It should be appreciated that any public communication interconnection is within the scope of the present invention. For example, the invention can be practiced and embodied using a local area network or an intranet rather than the Internet. Further, any communication network capable of electronic data transmission can be used to practice the invention.

Next, using an Internet web browser or other similar remotely located software interface, the user communicates with an Internet-based server through which bar coded Internet tickets are sold, (“the ticket provider”), and selects the event and time desired. Where implemented, the user also selects the specific seat desired for the event. The Internet server offers only unsold seats for purchase. Where permitted by the venue, the user may also elect to purchase concession-stand items individually, as pre-defined combination meals, or as flat-rate value certificates.

For general admission events, the Internet server next compares the total number of tickets already sold to a threshold set by the venue management. If this threshold would be exceeded by the sale of the tickets, the sale is declined. Once the threshold has been exactly reached, the Internet ticketing system automatically places the events into “administrative hold” mode so that no further tickets can be purchased on-line. The Internet ticketing system also automatically cuts off ticket sales for specific events at a pre-determined number of minutes prior to the event.

A default threshold for the venue, specific threshold for specific events, and the number of minutes required for pre-show cutoff are configurable by venue management. Venue management may also control event listings, show times, ticket prices, concession offerings, discount pricing, and venue information using software at the venue location, either through the supplied computer system or, if integrated with the venue box office system, using the functionality of the box office computer terminal.

Provided the proposed purchase passes all the requirements set by venue management, credit card or other electronic payment information is then collected through a checkout process. The payment is processed in real time, and if approved, a unique ticket identification number is generated and coupled, through a mathematical algorithm, with the unique venue identification number previously assigned to the venue for which the user is purchasing a ticket. This process generates a unique “ticket key.” Because of the nature of the algorithm and other elements, including the fact that the ticket identification number and venue identification number are generated based preferably upon the primary key of an SQL database, this combined “ticket key” is different from any other ticket key generated by the system.

In one embodiment, the format of the ticket key is entirely numeric. An example of such a ticket key includes fourteen (14) characters wherein some of the characters represent the venue identification number, while some of the characters represent the ticket identification number. It should be appreciated that other ticket keys including various different numeric and/or alphanumeric combinations and character lengths are within the scope of the present invention.

Next, an electronic component generates a bitmap (.BMP) format bar code image encoded with the ticket key generated as described above. Then the electronic component electronically and automatically converts this image to a format that can be displayed by most common HTML rendering engines (generally JPG or GIF format). The image generated can then displayed to the user in combination with a printed summary of the admissions and the concession items purchased. A credit card receipt can also be displayed. This displayed image depicts the user's “ticket.”

As used herein, the term “ticket” refers to the printed image including the ticket key described above. This term is used for illustrative purposes only and is not meant to be limiting in scope. It will be appreciated that a number of alternative terms may be used to describe the “ticket” including, but not limited to, “receipt”, “confirmation”, and the like, based on the preferences or requirements of the venue.

Next, the user prints the “ticket.” In one embodiment, the ticket is printed on standard 8.5×11-inch paper, which can be done successfully using most common printers. One of skill in the art will recognize that printing the ticket can be performed in a variety of ways on a variety of media by a variety of printers. In some embodiments, printing can be accomplished, depending upon the capabilities of the web browser or other software, using client-side scripting or by simply clicking the “print” button in the web browser or other software. The Internet server determines the actual method for delivery of the completed ticket after it electronically reviews the type of web browser or software being used by the client computer.

Further, it will be appreciated that tickets may differ based on the printing preferences or requirements of the different venues.

After the ticket is printed, the user removes it from the printer and takes it to the venue to gain admission to the event.

It should be appreciated that a user can purchase one ticket for each venue admission, or can purchase one ticket that includes multiple admissions. That is, the unique bar coded ticket can include more than one admission per ticket. Thus, a large group can gain access to a venue via one ticket purchased in accordance with the method and system of present invention.

Once the ticket has been successfully sold, data is transmitted to the venue computer to proprietary computer software that validates the tickets. The venue computer and its associated software are generally located at the “ticket-taker” location in the venue, but could also be located at the traditional box office windows. The software allows for multiple ticket-taking computers and software to be networked together using a local area network running any networking protocol. These computers may, at the option of venue management, be completely integrated into the existing box office and concession management software in use at the venue via a software application programming interface (“API”).

To reduce the risk of fraud, the transmission of data between the venue and the Internet server is conducted over a secure, encrypted transmission link, and accesses an extremely complex URL that is highly unlikely to ever be accidentally entered into a casual web surfer's web browser. Even if a casual surfer did happen to access the URL with a traditional web browser, however, the Internet server is configured to display an error message, which indicates to the user that the page was not found on the Internet server. By inspecting the format of the request, the Internet server can distinguish between the authorized software and a standard web browser. In addition, most elements of the request are encrypted using private-key technology. The chance of a user successfully accessing this data at all, much less being able to decrypt the encrypted transmission, and subsequently the further encrypted values within the decrypted data stream itself, is infinitesimal. Even if such a breach were to happen, the time required to successfully decrypt the data would make admission to the event in question meaningless.

Transmission of data between the venue and the Internet server may be initiated by either the venue computer system or by the Internet server. The format of the data transferred within the encrypted data stream varies depending upon the type of data being transferred, but includes HTML form elements and their associated values, interpretation of elements included as parts of the request (including such things as the TCP port on which the request is submitted), information stored in request headers, proprietary-format commands and functions, and industry-standard XML.

The types of data transmitted between the venue computer and the Internet server preferably include information about new tickets sold; summaries of total tickets sold; tickets actually scanned; updates regarding available tickets; initial information about and changes to dates and times of events; real-time requests for permission to sell tickets to an event; credit card and/or debit card processing requests and approvals; and the like.

Information about new tickets sold flows regularly from the Internet server to the venue on a pre-determined schedule (typically every 1-3 minutes depending on software settings at the venue). The venue initiates an encrypted request to the Internet server, which interprets the request, and authenticates the venue identification number and password supplied. If authentication is successful, the Internet server queries the ticketing information in the Internet server's database to determine if any additional tickets have been issued for this venue since the last synchronization between the systems took place. The Internet server creates an XML-format recordset containing complete information about any new tickets that were located in the database, and delivers it to the venue computer using the encrypted data link. This recordset includes information about each admission purchased, the price charged for each of those admissions, the concession items, combinations or certificates purchased and their values, and details about the event.

After receiving the XML-format recordset from the Internet server, the venue software adds the new tickets and all associated information into a local database file for reference at a later time.

Summary information about total tickets sold for each event for that day is displayed on a computer monitor connected to the venue's computer system. This summary information is displayed as an HTML page, which is retrieved from the Internet server periodically (typically every 1-3 minutes depending on software settings at the venue). The venue initiates an encrypted request to the Internet server, which authenticates the venue identification number and password. If authentication is successful, the Internet server queries the events and ticketing information in the database to summarize the number of tickets sold for each remaining event for that day at the specified venue. In addition, the Internet server determines the administrative hold status of each event from settings in the database.

The Internet server then builds the HTML page for display in the venue computer system, displaying events on administrative hold in an alternate color. In addition, the Internet server adds HTML form elements with control buttons that allow the venue manager to place each event on administrative hold or remove each event from administrative hold status at will. These form elements submit their data to the Internet server, which, after authentication, updates the database with the new administrative hold status, then rebuilds the HTML summary page for display on the venue's computer monitor.

Information about tickets actually scanned by the venue computer system is submitted to the Internet server each time a ticket is scanned successfully at the venue. This submission is sent to the Internet server along with the ticket identification number. The venue initiates an encrypted request to the Internet server, which authenticates the venue identification number and password. If authentication is successful, the Internet server updates the ticketing information in the database to indicate that that specific ticket identification number was scanned successfully, and makes a note of the time the scanning took place.

Where the venue computer system is integrated through an API with the existing box office ticketing system, information about tickets remaining for each show is submitted to the Internet server by the venue computer system each time the available ticket count for an event changes. The Internet server authenticates the venue identification number and password. If authentication is successful, the Internet server updates the event table in the SQL database to indicate the new available ticket count for that specific event. Future sales are then subject to this limitation, as well as the ticketing thresholds mentioned above.

Where the venue computer system is integrated through the API with the existing box office ticketing system, information about and changes to event dates and times is submitted to the Internet server by the venue computer system each time event information changes. The venue initiates an encrypted request to the Internet server, which authenticates the venue identification number and password. If authentication is successful, the Internet server updates the event information in the database to indicate the new information.

New events can be added via this same electronic interface. Events can also be deleted, but are subject to data integrity protection, i.e., an event to which a ticket has been sold cannot be deleted, but may be set to “inactive” status so that the Internet server may sell no additional tickets.

In a preferred embodiment, real-time ticketing integration is provided, i.e., the Internet server may be configured, optionally, to sell tickets only after making a real-time request of the venue's box office software for permission to sell tickets. The venue computer system and the Internet server may also, optionally, be configured to assign specific seats for an event. In each of these embodiments, the venue computer system and the Internet server are configured to maintain a persistent connection to each other; in other words, the encrypted data link is kept open at all times to facilitate rapid processing of requests for real-time tickets and exchange of data regarding available specific seats.

In a preferred embodiment, the present invention also provides validation and fraud protection at the venue. Preferably, the venue computer system validates and tracks tickets, and at least one venue computer is located at the ticket-taker or other location at the venue. Bar coded Internet tickets are preferably presented for acceptance at the venue computer system at the ticket-taker or other location, where a bar code scanner is used to read the ticket key from the ticket. If the quality of the printed bar code is inadequate, the operator uses a tool to enter the ticket key manually for validation. In some embodiments, such a tool is a numerical key pad. Other examples include, but are not limited to, an alphanumeric keyboard or voice recognition software. Once entered, the ticket key is inspected and compared to the venue identification number for the venue to which the ticket was submitted. If there is a mismatch between these two numbers, the ticket is immediately recognized as being invalid for the venue and probably fraudulent (barring any unlikely confusion regarding the proper venue for the event on the part of the user), and a bold message stating that the ticket is invalid appears on the venue computer system's monitor. At this point, the ticket-taker would generally reject the ticket's validity and not admit the user.

If the venue identification number matches, the ticket key is further inspected and the venue computer system attempts to locate the ticket identification number in its local database of valid tickets. If the ticket identification number cannot be found in the local database, the ticket is immediately recognized as being invalid (and almost certainly fraudulent), and a bold message stating that the ticket is invalid appears on the venue computer system's monitor. At this point, the ticket-taker would preferably reject the ticket's validity and not admit the user.

If the ticket identification number is found in the local database, the venue computer system checks to see if the ticket has been presented previously. If it has, the ticket is immediately recognized as being either a copy of another user's ticket or a ticket that has been incorrectly scanned twice. There is a very high likelihood that the ticket is a fraudulent copy, although this can be determined very easily by inspection of the ticket itself. Since the ticket-taker preferably removes the bar coded portion of the paper from successfully scanned tickets, he can generally determine if the ticket has been submitted previously by the same person, and might also search his own memory for a recollection of the user being admitted previously.

In any case, the venue computer system displays a message on the computer monitor that the ticket is indeed valid, and includes detailed information about admissions and concessions for this ticket identification number being submitted, which is drawn directly from its local database. If the ticket identification number was previously scanned, however, the system adds a bold message to this screen that indicates that the ticket was previously scanned. If this additional message were to appear, the ticket-taker would generally reject the ticket's validity and not admit the user.

Provided that the ticket scans successfully, the ticket-taker preferably compares the information on the computer monitor to the information printed in human-readable form on the ticket itself. If there is a mismatch, the ticket has been altered and is almost certainly fraudulent. At this point, the ticket-taker would generally reject the ticket's validity and not admit the user, or at the very least, allow admissions and concessions only to the extent reported by the venue computer system.

Once the ticket-taker is satisfied that the ticket is valid, he placed a validating insignia on the ticket. Preferably, the validating insignia is a stamp on the ticket in two places with a brightly colored rubber stamp, preferably one with an unusual shape that would be difficult to duplicate, or uses any similar method to indicate on the ticket itself that the ticket has been redeemed successfully. Typically, venue management changes the rubber stamp and its associated ink color, or other validating insignia, daily and at random, so that it would be unlikely for a user bent on committing fraud to guess in advance the validation stamp or insignia for any particular day. The ticket is stamped on both the concession certificate and the receipt portion of the ticket. The portion of the ticket that contains the bar code image is preferably removed by tearing along a dotted line across a sharp edge, after which the bar code portion is preferably deposited into a ticket stub container, and the remaining two pieces of the ticket, with their validating insignia, are returned to the user intact.

The user preferably retains the receipt portion of the ticket as a stub for re-entry. If items were purchased from the concession stand or from the gift shop, however, the remaining two portions of the ticket are preferably submitted intact to the concession stand or gift shop operator, who verifies the presence of the validating insignia, gives the user his concession stand or other items, and preferably removes the concession certificate portion of the ticket, which is then preferably placed into the concession stand cash drawer for end-of-day reconciliation.

In another preferred embodiment, a separate electronic scanner system might be located at the concession stand or gift shop for independent validation of tickets without the requirement of visiting the ticket-taker prior to redeeming the printed certificate for these items.

In another preferred embodiment, an unattended, self-service kiosk might be located in a publically accessible area of the venue, with provisions for the ticket buyer to scan the bar code themselves OR to manually enter the ticket key information. This kiosk is configured to print traditional entrance tickets on traditional ticketing paper stock or on any other sort of paper. The tickets printed by the kiosk are then redeemed at the ticket-taker location for entrance into the event.

Venues that adopt the bar coded Internet ticketing system of the present invention are optionally provided with an additional advantage of an API that provides a way to easily integrate the venue box office computer system with the on-line ticketing system. The API provides properties and methods that allow the box office software to update remaining ticket counts for each event, add/modify/delete events from the online ticketing system, retrieve on-line ticket sales summary and detail information, and send commands to the on-line system prohibiting further sales to a specific event once event sell-out draws near.

As should be apparent from the description above, the bar coded Internet ticketing system and method provides ticket issuance and validation that can be used at virtually any venue. The amusement park industry, for example, is particularly well suited for a bar coded Internet ticketing system in accordance with the present invention. Long lines (and crying children) can be avoided by simply installing a bar code Internet ticketing scanning/validating system at the amusement park entrance and setting up an on-line ticket office.

Other preferred embodiments that could make efficient use of the system of the present invention include, but are not limited to, ski resorts, museums, markets, nightclubs, bars and comedy clubs. Each of these venues could easily create an on-line ticket office using the bar coded Internet ticketing system as an on-line tool.

In addition, the bar coded Internet ticketing system can be adapted into an existing assigned-seat ticketing system, or can be expanded to offer seat-by-seat ticket sales.

It should also be appreciated that the present invention encompasses alternative coding systems and is not limited in scope to the bar coding described above. Machine coding of any type that provides the benefits of the present invention including, but not limited to, on-line purchasing, ease of printing, ticket validation, fraud prevention, and venue integration with the on-line ticketing system, shall fall within the scope of the present invention.

Further, in an alternate embodiment of the present invention, the Internet server provides downloaded information to a hand-held personal computer, organizer, cellular phone, or the like. The downloaded information includes a confirmation number that can be used for admission via validation at the ticket-taker computer.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope. The singular “a” and “an” shall include the plural, and shall mean “at least one or more” where appropriate in context.

What is claimed and desired to be secured by United States Letters Patent is:

1. A system for issuing a ticket for admission to a venue, comprising:
a) an Internet server capable of selling a ticket to a user, wherein the user can print the ticket directly from the Internet server;
b) an Internet connection between the user and the Internet server;
c) a venue computer system equipped to validate the ticket;
d) an Internet connection between the venue computer system and the Internet server.

2. A system in accordance with claim 1, wherein the Internet server tracks statistical information.

3. A system in accordance with claim 1, wherein the venue computer system configures venue and event settings on the Internet server.

4. A system in accordance with claim 1, wherein the connection used by the user is a basic modem dial-up connection, a high-speed dedicated circuit, a DSL or Cable connection, or a wireless connection.

5. A system in accordance with claim 1, wherein the Internet server is connected to the Internet via a high-speed dedicated circuit.

6. A system in accordance with claim 1, wherein the connection used by the venue computer system is a basic modem dial-up connection, a high-speed dedicated circuit, a DSL or Cable connection, or a wireless connection.

7. A system in accordance with claim 1, wherein the Internet server includes an Internet ticketing on-line database.

8. A system in accordance with claim 7, wherein the venue includes a box office computer system, and further comprising integration between the box office computer system and the Internet ticketing on-line database to facilitate tracking of ticket sales and event management in the Internet ticketing on-line database.

9. A system in accordance with claim 8, wherein the integration between the box office computer system and the Internet ticketing on-line database occurs in real time.

10. A system in accordance with claim 1, wherein the ticket includes a ticket key comprising a venue identification number and a ticket identification number.

11. A system in accordance with claim 10, wherein the ticket key comprises a bar code on a printed ticket.

12. A system in accordance with claim 11, further comprising a bar code scanner that validates the ticket.

13. A method for issuing a ticket for admission to a venue, comprising:
a) accessing an Internet web browser;
b) communicating with an Internet-based server to select an event and time desired;
c) comparing a total number of tickets already sold to a threshold set by the venue;
d) collecting and processing payment information through a checkout process;
e) generating a ticket identification number;
f) coupling the ticket identification number with a venue identification number for the venue for which the user is purchasing a ticket, thereby generating a ticket key;
g) generating an image encoded with the ticket key;
h) converting the image to a format that can be displayed by HTML rendering engines; and
i) printing the ticket.

14. A method in accordance with claim 13, wherein the ticket sale is declined if the threshold would be exceeded by the sale of the ticket.

15. A method in accordance with claim 13, wherein the server automatically cuts off ticket sales for specific events at a pre-determined number of minutes prior to the event once the threshold has been reached.

16. A method in accordance with claim 13, wherein a user selects a specific seat for the event prior to printing the ticket.

17. A method in accordance with claim 13, further comprising the step of making an electronic request in real-time to a venue server for permission to sell additional tickets to a specific event prior to selling additional tickets to the specific event.

18. A method in accordance with claim 13, wherein the ticket key comprises a unique bar code.

19. A system for notifying a venue that a bar coded Internet ticket has been sold, comprising:
a) a venue computer;
b) an Internet server that provides bar coded Internet tickets, the Internet server in communication with the venue computer;
wherein data that a ticket has been sold is transmitted between the Internet server and the venue computer.

20. A system in accordance with claim 18, wherein the venue computer includes bar coded Internet ticket processing software, and the venue includes a ticket-taker location.

21. A system in accordance with claim 19, wherein multiple venue computers and software located at the ticket-taker location are networked together using a local area network.

22. A system in accordance with claim 19, wherein the multiple computers are integrated into existing box office and concession management software in use at the venue via a software application programming interface.

23. A system in accordance with claim 19, wherein said data transmitted between the Internet server and the venue computer can be used to verify that a ticket has been sold.

24. A method for communicating information between a venue computer and a bar coded Internet ticket server, comprising:
a) transmitting data from the venue computer to the Internet server;
b) transmitting data from the Internet server to the venue computer;
wherein the data transmitted between the venue computer and the Internet server include information about new tickets sold, summaries of total tickets sold, tickets scanned, updates regarding available tickets, and/or changes to dates and times of events.

25. A method in accordance with claim 24, wherein transmission of data between the venue computer and the Internet server is conducted over a secure, encrypted transmission link.

26. A method for providing access to a venue by transmitting a bar coded ticket for the venue from a ticket provider to a customer over a public communication interconnection comprising:
a) transmitting a bar coded ticket from the ticket provider to the customer over the interconnection upon the request of the customer;
b) printing the unique bar coded ticket into a format that can be presented to obtain access to the venue;
c) presenting the printed ticket to access the venue.

27. A method in accordance with claim 26 wherein said venue is a movie theater.
